(19) United States
(12) Patent Application Publication
(10) Pub. No.: US 2022/0313401 A1
(43) Pub. Date: Oct. 6, 2022

(54) DATA INTEGRATION METHOD OF 3-DIMENSIONAL SCANNER AND SYSTEM USING SAME

(71) Applicant: MEDIT CORP., Seoul (KR)

(72) Inventors: Beom Sik SUH, Seoul (KR); Myoung Woo SONG, Seoul (KR)

(73) Assignee: MEDIT CORP., Seoul (KR)

(21) Appl. No.: 17/848,506

(22) Filed: Jun. 24, 2022

Related U.S. Application Data
(63) Continuation-in-part of application No. PCT/KR2020/019068, filed on Dec. 24, 2020.

(30) Foreign Application Priority Data
Dec. 26, 2019 (KR) 10-2019-0175291

(51) Int. Cl. A61C 9/00; A61C 13/00; A61C 7/00

(52) U.S. Cl. CPC A61C 9/006; A61C 13/0004; A61C 7/002

(57) ABSTRACT

According to the present disclosure, partial precision shape data is added to overall data by combining scan data obtained by a first scanner and a second scanner, respectively, and thus, missing data in a scan of the first scanner is supplemented by a scan of the second scanner. There is an advantage of being able to derive highly reliable data through such a supplementary process, and a user can provide a more suitable treatment to the patient.

### TECHNICAL FIELD

The present disclosure relates to a data integration method of a 3-dimensional intraoral scanner and a system using the same, and more specifically, to a data integration method capable of allowing other scan data to supplement deficiencies in data acquired from any one scan data by integrating different forms of scan data, and a system using the same.

### BACKGROUND ART

A 3-dimensional scanning technology is used in various industrial fields such as reverse engineering, measurement, inspection, content creation, and CAD/CAM, and increasingly used in various fields as scanning performance is increased due to the development of a computing technology.

In the conventional dental prosthetic treatment field, a therapist acquires a plaster using a material for dental treatment such as alginate in order to acquire shape information on the patient's affected part (inside the oral cavity, that is, the patient's teeth, gums, jawbone, or the like). The therapist produces a dental treatment prosthesis or the like based on the acquired plaster. At this time, the specification of the prosthesis is manually determined and produced with respect to the plaster. Accordingly, as errors occur due to the manual production of the prosthesis, there is a disadvantage that the prosthesis does not fit accurately when actually applied to the patient's affected part.

To solve the disadvantage, the operation of positioning the impression-acquired plaster in the scanning space, and converting the plaster into digital data by performing the 3-dimensional scanning has been proposed. When the mock-up is converted into the digital data, the numerical data becomes more precise, so that it is possible to provide the prosthesis more suitable for the patient.

However, when the plaster is scanned, the scan data for the entire arch is accurate, but there is a case in which additional measurements are partially required. For example, it is necessary to improve the data precision through additional measurement for an interdental part, which is a part between the teeth, a marginal part of the abutment of the plaster, a contact part between the adjacent teeth, or the like. In addition, since it is difficult to measure metal parts (abutments of implants, crowns, and the like) due to light reflection, it is important to acquire precise data on these parts.

### SUMMARY OF INVENTION

### Technical Problem

An object of the present disclosure is to provide a data integration method of a 3-dimensional scanner, which derives precise scan results by combining (integrating) scan data of a second scanner to scan data acquired by a first scanner.

In addition, another object of the present disclosure is to provide a data integration system of a 3-dimensional scanner, which collects scan data of a first scanner and a second scanner to convert the collected scan data into 3-dimensional voxel data in a calculation unit, and combines the same forms of data to supplement the scan data.

### Solution to Problem

A data integration method of a 3-dimensional scanner according to the present disclosure may include a first scan operation of generating first raw data by capturing the entire shape of a subject by a first scanner, a second scan operation of generating second raw data by continuously capturing a partial shape of the subject by a second scanner, a data converting operation of converting the first raw data generated in the first scan operation and the second raw data acquired from the second scan operation into file data of the same format, and a data combining operation of combining the data in the second scan operation converted in the converting operation and the data of the first scan operation converted in the converting operation to overlap each other.

In addition, the first scanner may include an imaging unit having a predetermined angle and a predetermined distance interval toward the subject in order to generate the first raw data by capturing the subject.

In addition, the first scanner may have the imaging unit capturing the subject illuminated by light irradiated through a light projector formed in the first scanner.

In addition, the first scanner may further include a first rotating unit coupled to one surface thereof to be rotatable clockwise or counterclockwise with respect to one axis, and formed to be bent in one direction, and a second rotating unit coupled to one end of the first rotating unit, and rotatable clockwise or counterclockwise with respect to one axis.

In addition, the second scanner may have a freely adjustable capturing angle and capturing distance for the subject, and continuously capture the partial shape of the subject so that the partial shapes of the subject overlap.

In addition, the second scanner may be a handheld scanner including a case that is drawn into and drawn out from an oral cavity, and is formed with an opening that is open so that a state inside the oral cavity is incident therein in the form of light through one end, an imaging unit disposed inside the case, and configured to accommodate light incident through the opening of the case, a light irradiation unit disposed at one side of the imaging unit, and configured to emit light to irradiate the state inside the oral cavity through the opening, and an optical element configured to illuminate the subject by refracting or reflecting light generated from the light irradiation unit, and cause light reflected from the subject to enter the imaging unit.

In addition, the second raw data may be 3-dimensional surface data.

In addition, light emitted from the light irradiation unit may be structured light having a specific pattern.

In addition, a format of the file data converted in the data converting operation may be voxel data having a format of 3-dimensional volume data.

Meanwhile, a data integration method of a 3-dimensional scanner according to another embodiment of the present disclosure may include a first scan operation of scanning a subject through a first scanner, a modeling operation of forming a 3-dimensional model of the subject based on data acquired in the first scan operation, a second scan operation of scanning a specific area of the subject corresponding to a supplementary area requiring an additional scan in the 3-dimensional model through the second scanner, and a supplementing operation of supplementing the supplementary area based on data acquired in the second scan operation.

In addition, the supplementing operation may overlap or replace the data acquired in the second scan operation with at least a part of the data acquired in the first scan operation.

In addition, the first scan operation may scan the entire shape of the subject at a preset capturing angle and capturing distance, and the second scan operation may scan a partial shape of the subject at a free capturing angle and capturing distance.

In addition, the preset capturing angle and capturing distance in the first scan operation are changeable while the first scan operation is performed.

Meanwhile, a data integration system of a 3-dimensional scanner according to the present disclosure may include a first scanner configured to scan a subject at a preset capturing angle and capturing distance, a second scanner configured to scan the subject at a free capturing angle and capturing distance, and a calculating unit configured to supplement a supplementary area requiring an additional scan in a 3-dimensional model of the subject implemented by the scan data of the first scanner with the scan data of the second scanner.

In addition, the first scanner and the second scanner may be connected to a device including the calculating unit wirelessly or by wire.

In addition, the first scanner and the calculating unit may be configured as an integrated device, and the second scanner may be connected to the integrated device wirelessly or by wire.

In addition, the data integration system may further include a display unit configured to display the 3-dimensional model.

In addition, the second scanner may be a handheld scanner including a case that is drawn into and drawn out from an oral cavity, and is formed with an opening that is open so that a state inside the oral cavity is incident therein in the form of light through one end, an imaging unit disposed inside the case, and configured to accommodate light incident through the opening of the case, a light irradiation unit disposed at one side of the imaging unit, and configured to emit light to irradiate the state inside the oral cavity through the opening, and an optical element configured to illuminate the subject by refracting or reflecting light generated from the light irradiation unit, and cause light reflected from the subject to enter the imaging unit.

### Advantageous Effects of Invention

According to the data integration method of the 3-dimensional scanner according to the present disclosure configured as described above, the subject installed on the tray can have 2 or more degrees of freedom by forming the rotating unit composed of the first rotating unit and the second rotating unit in the first scanner, so that the subject can be freely tilted and thus captured from various angles by the imaging unit.

In addition, according to the data integration method of the 3-dimensional scanner according to the present disclosure, it is possible to mutually compensate for the disadvantages of each scanner by forming the 3-dimensional volume data of the subject as a whole in the first scan operation, partially forming the 3-dimensional volume data of the subject in the second scan operation, and then converting the 3-dimensional volume data into the 3-dimensional voxel data that may be overwritten with the 3-dimensional volume data of the subject and combining them.

In addition, it is possible to acquire more precise data, and eventually provide the treatment service such as precise prosthetic treatment product to the patient.

### BRIEF DESCRIPTION OF DRAWINGS

FIG. 1 is a schematic flowchart of a data integration method of a 3-dimensional scanner according to the present disclosure.

FIG. 2 is a perspective view of a first scanner in the data integration method of the 3-dimensional scanner according to the present disclosure.

FIGS. 3A and 3B show a user interface display screen according to subject scan results from the first scanner in the data integration method of the 3-dimensional scanner according to the present disclosure.

FIG. 4 is a perspective view of a second scanner in the data integration method of the 3-dimensional scanner according to the present disclosure.

FIG. 5 is a view schematically showing a configuration of the second scanner in the data integration method of the 3-dimensional scanner according to the present disclosure.

FIG. 6 is a view schematically showing the scanning of the second scanner in the data integration method of the 3-dimensional scanner according to the present disclosure.

FIGS. 7A and 7B show a user interface display screen representing a 3-dimensional model in which at least one of a contact part between adjacent teeth and a supplementary area is supplemented according to subject scan results from the second scanner in the data integration method of the 3-dimensional scanner according to the present disclosure.

FIG. 7C is a view for describing supplementary data within the supplementary area.

FIG. 8 is a flowchart of a data integration method of a 3-dimensional scanner according to another embodiment of the present disclosure.

FIG. 9 is a schematic view of a data integration system of a 3-dimensional scanner according to the present disclosure.

### DESCRIPTION OF EMBODIMENTS

Advantages and features of the present disclosure and methods of achieving them will be made clear from embodiments described in detail below with reference to the accompanying drawings. However, the present disclosure is not limited to embodiments disclosed below but will be implemented in various different forms, and only these embodiments are provided so that the disclosure of the present disclosure will be thorough and complete and will fully convey the scope of the present disclosure to those skilled in the art to which the present disclosure pertains, and the present disclosure is defined by the description of the claims. The same components are denoted by the same reference numerals throughout the specification.

Hereinafter, an embodiment of the present disclosure will be described in detail with reference to the drawings.

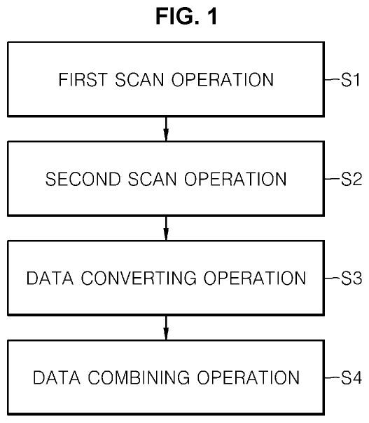

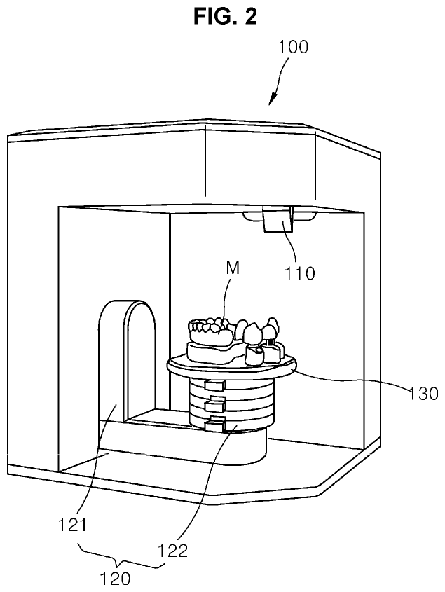

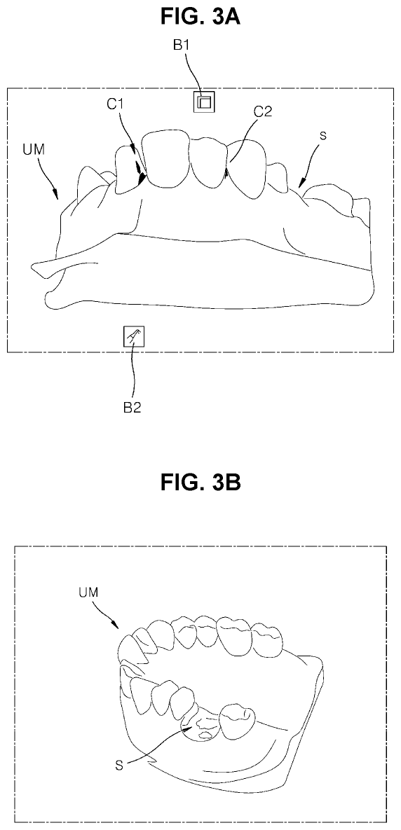

FIG. 1 is a schematic flowchart of a data integration method of a 3-dimensional scanner according to the present disclosure, FIG. 2 is a perspective view of a first scanner in the data integration method of the 3-dimensional scanner according to the present disclosure, and FIGS. 3A and 3B show a user interface display screen according to subject scan results from the first scanner in the data integration method of the 3-dimensional scanner according to the present disclosure.

Referring to FIG. 1, a data integration method of a 3-dimensional scanner according to the present disclosure includes a first scan operation (S1) of generating first raw data by capturing the entire shape of a subject from a first scanner, and a second scan operation (S2) of generating second raw data by continuously capturing a partial shape of the subject from a second scanner.

FIG. 2 shows a perspective view of a first scanner 100. At this time, the first scanner 100 may be a table scanner that disposes a subject in a prepared capturing space and performs a scan. The first scanner 100 is not configured so that the first scanner 100 rotates by itself around the subject, but may be formed to capture a subject M disposed in the first scanner 100 from various angles. The subject M may be a plaster acquired by an impression acquiring process (the plaster is referred to as a subject in the following description).

In addition, an inner wall surface of the first scanner 100 may be provided with a first rotating unit 121 rotatable clockwise or counterclockwise with respect to one axis, and formed to be bent in one direction, and a second rotating unit 122 coupled to one end of the first rotating unit 121, and rotatable clockwise or counterclockwise with respect to an axis different from that of the first rotating unit 121. For example, the second rotating unit 122 may rotate clockwise or counterclockwise with respect to an axis perpendicular to the first rotating unit 121. At this time, the subject M is installed on a tray 130 formed on the second rotating unit 122. A rotating unit 120 composed of the first rotating unit 121 and the second rotating unit 122 is formed in the first scanner 100, so that since the subject M installed on the tray 130 has 2 or more degrees of freedom, the subject M may be freely tilted and thus captured by an imaging unit 110 from various angles.

Although FIG. 2 shows that the subject M may perform a rotating motion with 2 degrees of freedom by the first and second rotating units 121 and 122, the present disclosure is not limited thereto. For example, the rotating unit 120 may also be formed to be movable in parallel, and in this case, the subject M may be moved to have 5 or more degrees of freedom. As the degree of freedom regarding the movement and rotation of the subject M increases, the arrangement position and captured angle of the subject M get diverse through the rotating unit 120 of th first scanner 100, and the first scanner 100 may capture the subject M more precisely.

Meanwhile, the first scanner 100 may further include a light projector 140 configured to illuminate the subject M, and light irradiated from the light projector 140 may be light having a wavelength in a visible ray region. In addition, light irradiated from the light projector 140 may function to convert the captured image into 3-dimensional volume data in addition to the purpose of simply capturing the subject M. To convert the captured image into the 3-dimensional volume data, light irradiated from the light projector 140 may be structured light having a specific pattern. At this time, the 3-dimensional volume data may be voxel data, and a process of converting the first raw data into the 3-dimensional volume data may be performed together with the process of converting the second raw data into the 3-dimensional volume data, which will be described later.

In other words, structured light is irradiated to the subject M through the light projector 140, and the first rotating unit 121 and the second rotating unit 122 configuring the rotating unit 120 rotate the subject M disposed on the tray 130, so that the first scanner 100 captures the subject M from various angles. The imaging unit 110 configured to receive light reflected from the subject M may digitally image the accommodated light to generate (acquire) the first raw data, and convert the first raw data into 3-dimensional volume data. Meanwhile, at least one imaging unit 110 may be formed to have a predetermined angle and a predetermined distance interval toward the subject M. The imaging unit 110 may be formed to have the predetermined angle and the predetermined distance interval toward the subject M, and the at least one imaging unit 110 may be formed to be fixed to the first scanner 100. The imaging unit 110 is formed to be fixed to the first scanner 100, so that the imaging unit 110 may stably accommodate an image of the subject M.

However, the imaging unit 110 may be formed to have the predetermined angle and the predetermined distance interval toward the subject M, but a capturing angle and a capturing distance in which the imaging unit 110 captures the subject M may be changed by the rotating operation of the rotating unit 120. As described above, when the capturing angle and the capturing distance are variously changed, it is possible to obtain more accurate 3-dimensional volume data for the subject M.

FIGS. 3A and 3B show a user interface display screen according to subject scan results from the first scanner in the data integration method of the 3-dimensional scanner according to the present disclosure. FIGS. 3A and 3B show a 3-dimensional model UM of the subject M on a user interface (UI) screen. The 3-dimensional model UM of the subject M may be displayed through the display unit to be described later. The 3-dimensional model UM of the subject M is a result displayed when the first scanner 100 scans the subject M by clicking a first scan button B1 disposed on the user interface screen. However, there is left a space that needs to be supplemented data-wise for the interdental part, the marginal part of the abutment, contact parts C1 and C2 between adjacent teeth, and the metal parts. This will be defined as a supplementary space S. When the data for the supplementary space S is not supplemented, there is a disadvantage in that it is difficult to provide a precise prosthesis to the patient.

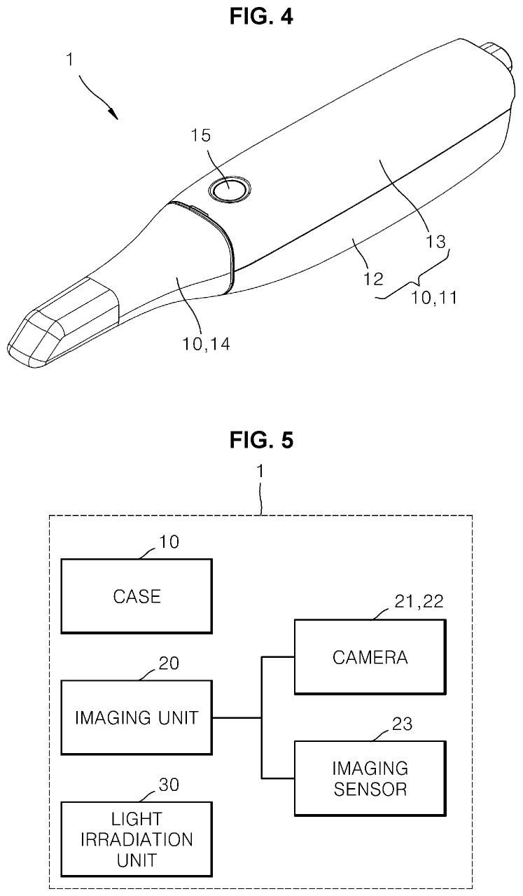

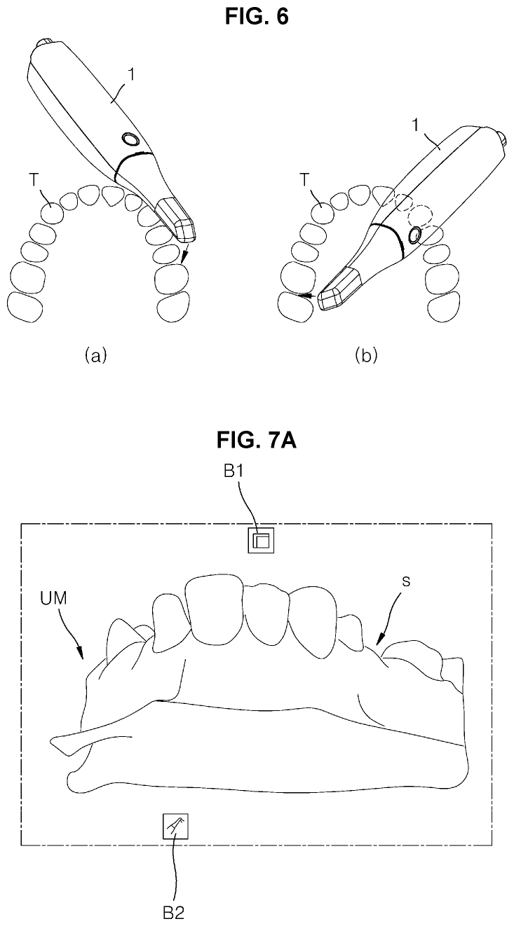

FIG. 4 is a perspective view of a second scanner 1 in the data integration method of the 3-dimensional scanner according to the present disclosure, FIG. 5 is a view schematically showing a configuration of the second scanner 1 in the data integration method of the 3-dimensional scanner according to the present disclosure, and FIG. 6 is a view schematically showing the scanning of the second scanner 1 in the data integration method of the 3-dimensional scanner according to the present disclosure.

Referring to FIGS. 4 to 6, to resolve the above disadvantage, the user may additionally capture the subject M using the second scanner 1. The data acquired by additionally capturing the subject M using the second scanner 1 may supplement the data acquired by using the first scanner 100, and the user may acquire the data that is more precise and similar to the patient's affected part. Accordingly, the user may provide a more suitable treatment to the patient. The second scanner 1 may perform a scan as it is directly drawn into and drawn out from the patient's oral cavity. In addition, the second scanner 1 may also scan the subject M. When capturing the subject M, the second scanner 1 may adjust the capturing angle or the capturing distance more freely than the first scanner 100, and continuously capture the partial shape of the subject M so that the partial shapes of the object M overlap.

In addition, the second scanner 1 may be a hand-held type intraoral scanner including a case 10 that may be drawn into and drawn out from the oral cavity and is formed with an opening that is open so that a state inside an oral cavity is incident therein in the form of light through one end, an imaging unit 20 disposed inside the case 10, and configured to receive light incident through the opening of the case, a light irradiation unit 30 disposed at one side of the imaging unit 20, and configured to emit light to irradiate the state inside the oral cavity through the opening, and an optical element (not shown) configured to illuminate the subject M by refracting or reflecting light generated from the light irradiation unit 30, and cause light reflected from the subject M to enter the imaging unit 20.

The second scanner 1 may include a tip case 14 configured to enable the second scanner 1 to be drawn into and drawn out from the oral cavity, and a main body case 11 that is a part gripped by a user (a therapist, and typically a medical practitioner such as a dentist uses the second scanner) by hand, and is formed by being coupled with the tip case 14. The main body case 11 includes a lower case 12 and an upper case 13, and the lower case 12 and the upper case 13 are coupled to protect parts inside the main body case 11.

In addition, the imaging unit 20 configured to accommodate light incident through the opening formed at one end of the tip case 14 is formed inside the main body case 11. At this time, the imaging unit 20 may generate image data (i.e., second raw data) by accommodating light. More specifically, the imaging unit 20 may include cameras 21 and 22. At this time, the cameras 21 and 22 may be a single camera, or may also be two or more multi-cameras spaced apart from each other by a predetermined interval. Light accommodated through the cameras 21 and 22 may be converted into image data by an imaging sensor 23 telecommunicatively connected to the cameras 21 and 22. At this time, the imaging sensor 23 may be a CMOS sensor or a CCD sensor, but this is illustrative, and the present disclosure is not limited thereto.

Meanwhile, the light irradiation unit 30 is formed at one side of the imaging unit 20 to emit light toward the optical element (not shown) formed inside the tip case 14. Light emitted from the light irradiation unit 30 may be light having a wavelength in the visible ray region, and may also be structured light having a specific pattern to later convert the image data into 3-dimensional volume data. The emitted light reaches the optical element to be refracted or reflected, and is irradiated to the subject M through the opening formed at one end of the tip case 14. At this time, the subject M may be a plaster or the like obtained by acquiring the impression of the patient's affected part. In other words, the subject M may be obtained by acquiring a target T such as the patient's affected parts, that is, teeth and gums inside the oral cavity. Preferably, the part of the subject M scanned by the second scanner 1 is a part corresponding to the supplementary space S in the 3-dimensional model UM of the subject acquired by scanning the subject M using the first scanner 100.

Light irradiated to the subject M is reflected from the surface of the subject M to be incident on the optical element again, and is accommodated in the imaging unit 20 disposed inside the main body case 11. The accommodated light is analyzed by the imaging sensor 23 formed on an imaging board and generated as the second raw data. At this time, a format of the second raw data is data of a projected shell format, which is a format different from a rangeimage that is the format of the first raw data. Alternatively, the second raw data may be 3-dimensional surface data generated by converting the 2-dimensional image data into the 3-dimensional image data. Since the second scanner 1 captures the surface of the subject M, the data acquired by capturing the surface of the subject M using the second scanner 1 may also be surface data.

Meanwhile, the second raw data may be converted into 3-dimensional volume data by a calculation unit telecommunicatively connected to the first scanner 100 and the second scanner 1 (data converting operation (S3)). At this time, the 3-dimensional volume data may be voxel data having information on the brightness intensity of light. Accordingly, when the second raw data is converted into voxel data that is 3-dimensional volume data, the 3-dimensional volume data has the same format as the 3-dimensional volume data converted from the first raw data. Accordingly, the first raw data and the second raw data are converted into file data (i.e., 3-dimensional volume data) of the same format, thereby enabling mutual compatibility.

Meanwhile, the data converting operation (S3) may convert the first raw data acquired in the first scan operation (S1) and the second raw data acquired in the second scan operation (S2) into the file data of the same format at once by the calculating unit. For example, the data converting operation (S3) may convert the first raw data and the second raw data into voxel data that is 3-dimensional volume data at once. Since the raw data converted into the 3-dimensional volume data has the same file format, the raw data may be easily combined in a subsequent data combining operation (S4), and insufficient data may be supplemented. The calculating unit may be a processor (e.g., a central processing unit of a computer) having a computation ability), and for example, may be formed to be spaced apart from the first scanner and the second scanner, and connected to the first scanner and the second scanner by wire or wirelessly. As another example, the calculating unit may be a processor of a device that is built in the first scanner and integrated with the first scanner, and the second scanner may be connected to the device in which the first scanner and the calculating unit are integrated by wire or wirelessly

When the data conversion of the second raw data is completed, the converted 3-dimensional volume data of the second raw data is combined with the converted 3-dimensional volume data of the first raw data to overlap each other (data combining operation (S4)). At this time, the combining to overlap each other may mean that the part corresponding to the supplementary area S in the 3-dimensional model UM of the subject acquired by the first scanner 100 scanning the subject M is overwritten with the 3-dimensional volume data acquired by the data conversion of the second raw data.

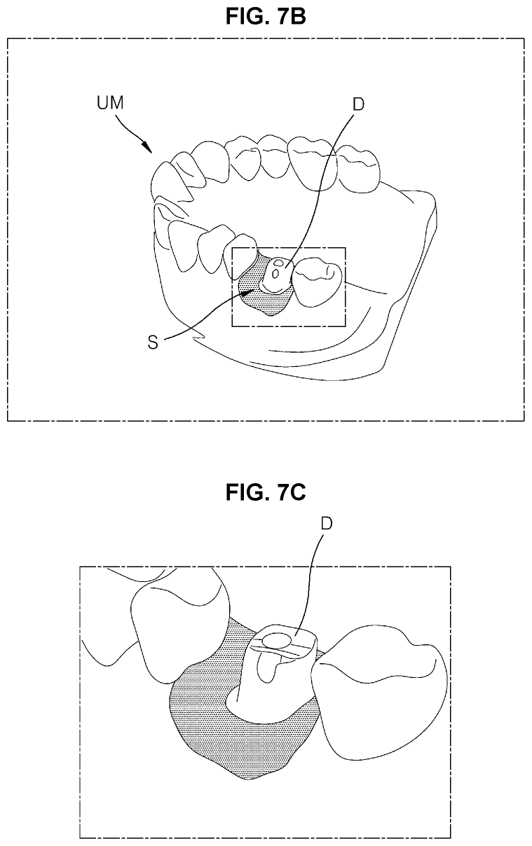

FIGS. 7A and 7B show a user interface display screen representing a 3-dimensional model in which at least one of a contact part between adjacent teeth and a supplementary area is supplemented according to subject scan results from the second scanner in the data integration method of the 3-dimensional scanner according to the present disclosure, and FIG. 7C is a view for describing supplementary data within the supplementary area.

Referring to FIG. 7A, it may be confirmed that the supplementary area S is formed by the scan of the first scanner 100. The first scanner 100 may scan the subject as a whole, and scan a relatively bulky object. However, it is difficult for the first scanner 100 to measure the precise dimensions of the interdental part, the marginal part of the abutment, and the contact part between the adjacent teeth. In addition, when the first scanner 100 is used to scan a part such as a metal object in the supplementary area S, there exists a disadvantage in that the part is not precisely scanned. To resolve the disadvantage, conventionally, a pin operation (applying a spray to a metal object or the like) for removing reflected light is additionally performed. By the operation, the volume of the operated part may increase, and the reliability of the overall data may be degraded. Accordingly, the interdental part, the marginal part of the abutment, the contact part between the adjacent teeth, or the part corresponding to the supplemental area S is scanned through the second scanner 1.

Referring to FIG. 7B, since the second scanner 1 has a freer capturing angle and capturing distance than those of the first scanner 100, it is possible to precisely scan supplementary data D including highly reflective metal objects. Referring to FIGS. 7B and 7C, the supplementary area S indicated in the form of a box with a dashed dotted line is supplemented with the supplementary data D by the second scanner 1, thereby completing a more precise 3-dimensional model UM. By supplementing the supplementary area S with the supplemental data D by the second scanner 1, the user may acquire the precise 3-dimensional model UM, and the user may provide a suitable treatment to the patient.

In addition, when the 3-dimensional scan is performed only by the second scanner 1, which is a handheld scanner, a measurement angle of the imaging unit is formed to be smaller than that of the table scanner, so that it is difficult to measure a large area, and it takes a long time to take a picture. Accordingly, according to the data integration method of the 3-dimensional scanner according to the present disclosure, it is possible to mutually compensate for the disadvantages of each scanner by forming the first raw data of the subject M as a whole using the first scanner 100 in the first scan operation (S1), partially forming the second raw data of the subject M using the second scanner 1 in the second scan operation (S2), and then converting the first raw data and the second raw data into the 3-dimensional volume data having the same format and combining them.

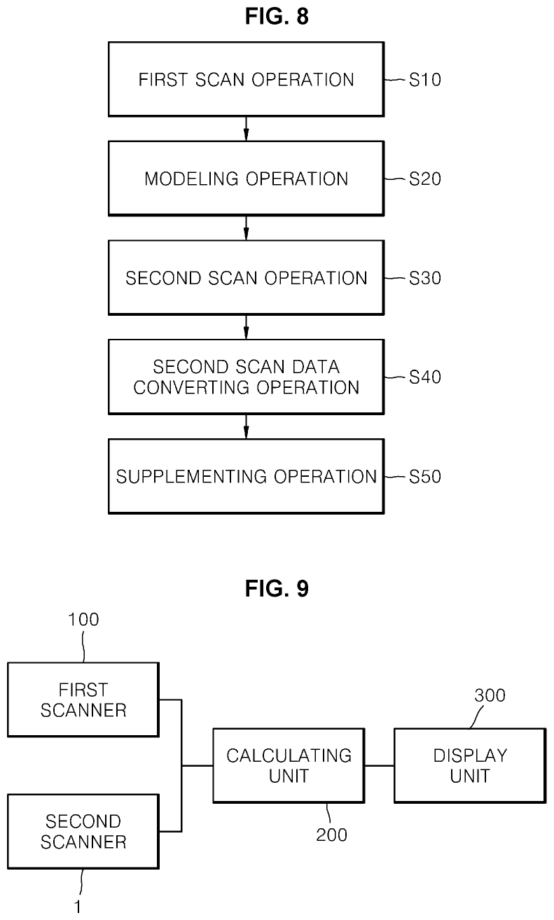

FIG. 8 is a flowchart of a data integration method of a 3-dimensional scanner according to another embodiment of the present disclosure.

Referring to FIG. 8, the data integration method of the 3-dimensional scanner according to another embodiment of the present disclosure may include a first scan operation (S10) of generating image data (first raw data) by scanning the entire shape of the subject M by the scanner 100, and a modeling operation (S20) of forming a 3-dimensional model of the subject by the calculating unit based on the image data (the first raw data) generated in the first scan operation (S10). In the first scan operation (S10), the first scanner 100 captures the entire shape of the subject M, and at this time, the first scanner 100 may be a table scanner including an imaging unit having a predetermined angle and a predetermined distance interval with the subject M. The imaging unit may be formed as one single camera in one direction, but is preferably formed to have two or more multi-cameras for acquiring more precise data by capturing the subject M from multiple angles. Here, scanning the entire shape of the subject M means performing capturing so that the entire shape of the subject M falls within the view angle of the first scanner 100.

Meanwhile, the image data generated in the first scan operation (S10) may be 2-dimensional data, and the image data at this time has a rangeimage format. In addition, to convert the generated image data into 3-dimensional volume data, structured light may be irradiated to the surface of the subject M. At this time, structured light may be irradiated from a light projector formed at one side of the imaging unit of the first scanner 100, and preferably, light irradiated from the light projector may be structured light having a wavelength in the visible ray region. By irradiating light from the light projector, it is possible to minimize a shaded portion of the subject M, and convert the 2-dimensional image data into the 3-dimensional volume data. By irradiating the structured light to the subject, the imaging unit of the first scanner 100 may acquire the 2-dimensional image data (i.e., the first raw data) including the pattern of the structured light, and the calculating unit built in the first scanner or formed to be spaced apart from the first scanner may convert the 2-dimensional image data into 3-dimensional volume data based on depth information included in the 2-dimensional image data by the pattern of the structed light.

In addition, when the first scanner 100 scans the subject M, a capturing angle and a capturing distance at which the subject M is captured may be adjusted to acquire precise data as a whole with respect to the subject M. At this time, to adjust the capturing angle and the capturing distance, the rotating unit 120 on which the tray 130 on which the subject M is installed is placed may be operated. The capturing angle and the capturing distance between the imaging unit 110 and the subject M may be changed by the operation of the rotating unit 120 in the first scan operation (S10).

Meanwhile, the 3-dimensional volume data generated by the first scanner 100 in the modeling operation (S20) have the possibility that the metal material part with high light reflection has not been expressed, or the interdental part, the marginal part of the abutment, the contact part between the adjacent teeth, or the like has not been precisely expressed.

To supplement the 3-dimensional volume data generated by the first scanner 100, the data integration method of the 3-dimensional scanner according to the present disclosure may further include a second scan operation (S30) of forming image data (second raw data) by capturing a specific part of the subject M requiring an additional scan through the second scanner 1, and a second scan data converting operation (S40) capable of converting the image data generated in the second scan operation (S30) into 3-dimensional volume data. At this time, the second scanner 1 used in the second scan operation (S30) may be a handheld type intraoral scanner. The second scanner 1 may freely adjust the angle and the distance in the relationship with the subject M due to the characteristics of the handheld type scanner. However, the second scanner 1 continuously scans a relatively smaller range because it has a smaller view angle compared to the first scanner 100 when performing the scan.

In addition, in the second scan data converting operation (S40), the calculating unit converts the 2-dimensional image data (i.e., the second raw data) acquired in the second scan operation (S30) into the 3-dimensional volume data. At this time, the 2-dimensional image data acquired in the second scan operation (S30) has the format of a projected shell, which is a format different from the rangeimage. Accordingly, by converting the 2-dimensional image data acquired in the second scan operation (S30) into the 3-dimensional volume data by the calculating unit, the 2-dimensional image data is overlapped or replaced with the converted 3-dimensional volume data in the modeling operation (S20). Meanwhile, at this time, the format of the 3-dimensional volume data may be voxel data in which information of a corresponding pixel is built in a pixel having a volume.

The data integration method of the 3-dimensional scanner according to the present disclosure may perform a supplementing operation (S50) of supplementing the supplementary area S by overwriting the supplementary data D by continuously capturing the partial shape of the subject M using the second scanner 1 so that the partial shapes of the subject M overlap. The supplementing operation (S50) may be performed by the calculating unit. Accordingly, the supplementary area S is supplemented with the supplementary data D, so that it is possible to precisely express the highly reflective metal part, the interdental part, the margin part of the abutment, the contact part between the adjacent teeth, or the like to acquire highly reliable 3-dimensional model, and eventually improve the quality of treatment by providing a suitable prosthesis to the patient or the like. At this time, supplementing the supplementary area S by overwriting the supplementary data D means that the 3-dimensional volume data converted from the first raw data overlaps the 3-dimensional volume data converted from the second raw data, or the 3-dimensional volume data converted from the second raw data replaces a part of the 3-dimensional volume data converted from the first raw data.

Hereinafter, a data integration system of a 3-dimensional scanner according to the present disclosure will be described.

FIG. 9 is a schematic view of a data integration system of the 3-dimensional scanner according to the present disclosure. The data integration system of the 3-dimensional scanner according to the present disclosure may include the first scanner 100 configured to generate the first raw data by capturing the entire shape of the subject M at a preset capturing angle and capturing distance, and the second scanner 1 configured to generate the second raw data by continuously capturing the partial shape of the subject M at a free capturing angle and capturing distance.

First, the first scanner 100 configured to capture the subject M may include the first rotating unit coupled to one surface thereof to be rotatable clockwise or counterclockwise with respect to one axis, and formed to be bent in one direction, and the second rotating unit coupled to one end of the first rotating unit and rotatable clockwise or counterclockwise with respect to one axis. The axis that is a reference when the second rotating unit rotates may be different from the axis that is reference when the first rotating unit rotates. For example, the axis that is a reference when the second rotating unit rotates may be perpendicular to the axis that is reference when the first rotating unit rotates.

Meanwhile, a tray may be formed on the second rotating unit, and the subject may be disposed on and fixed to the tray. The subject fixed to the tray is rotatable by the first and second rotating units and reflects light irradiated from the light projector formed on one surface of the first scanner 100, so that the reflected light may be accommodated in the imaging unit formed at one side of the light projector to generate the first raw data. At this time, the first raw data may have the format of a rangeimage. In addition, a capturing angle and a capturing distance when the imaging unit captures the subject may vary according to the rotation of the rotating unit. The configuration and operation of the first scanner 100 are the same as described above.

In addition, the second scanner 1 configured to capture the subject may include a case that may be drawn into and drawn out from the patient's oral cavity and including an opening having an open one end, an imaging unit formed inside the case to accommodate light reflected from the subject, a light irradiating unit disposed at one side of the imaging unit to emit light to irradiate the state inside the oral cavity through the opening, and an optical element (not shown) configured to illuminate the subject by refracting or reflecting light generated from the light irradiation unit, and cause light reflected from the subject to enter the imaging unit. Detailed components of the second scanner 1 are the same as described above.

In addition, the data integration system of the 3-dimensional scanner according to the present disclosure may include a calculating unit 200 configured to convert the first raw data and the second raw data into file data of the same format. As described above, since the first raw data has the data format of the rangeimage, and the second raw data has the data format of the projected shell, the first raw data and the second raw data are heterogeneous data. Since data may not be combined between the heterogeneous data, it is necessary to convert the first raw data and the second raw data into mutually compatible formats, respectively.

First, the calculating unit 200 converts the first raw data acquired by the first scanner 100 into voxel data in the form of 3-dimensional volume data. At this time, the voxel data is a pixel having a volume, and information such as a shape, color, and brightness intensity of the corresponding pixel may be inserted into the voxel. A 3-dimensional model of the subject converted into the voxel data is shown in FIGS. 3A and 3B.

Thereafter, the calculating unit 200 converts the second raw data acquired by the second scanner 1 into voxel data in the form of 3-dimensional volume data. Accordingly, since the first raw data and the second raw data are converted into the same format of data, they may be aligned and overlapped with each other. The calculating unit 200 supplements the supplementary area by combining supplementary data with the 3-dimensional model of the subject. This means that the area S of the scan data (the first raw data) of the subject scanned by the first scanner 100 requiring supplementation is supplemented with the scan data (the second raw data) of the subject M scanned by the second scanner 1, and here, the ‘supplementation’ may mean that the 3-dimensional volume data converted from the second raw data overlaps a part of the 3-dimensional volume data converted from the first raw data. More specifically, supplementing the supplementary area means that the 3-dimensional volume data converted from the second raw data replaces at least a part of the 3-dimensional volume data converted from the first raw data. Accordingly, the user may acquire more precise data, and as a result, it is possible to provide a suitable treatment service to the patient.

In addition, the calculating unit 200 may be formed to be spaced apart from the first scanner 100 and the second scanner 1. The calculating unit 200 may be generally a processor having a calculating capability according to an electrical signal, and may be, for example, a central processing unit (CPU) of a personal computer. The calculating unit 200 may be connected to the first scanner 100 and the second scanner 1 by wire or wirelessly to acquire and convert the scan data (the first raw data) of the first scanner 100 and the scan data (the second raw data) of the second scanner 1, and perform an overlapping calculation of the first scanner 100 and the second scanner 1.

Meanwhile, the calculating unit 200 may be a processor of a device integrated with the first scanner 100, which is built into the first scanner 100. At this time, the second scanner 1 may be connected to a device in which the first scanner 100 and the calculating unit 200 are integrated by wire or wirelessly.

Meanwhile, the converting process of the first raw data and the second raw data into the 3-dimensional volume data by the calculating unit 200 and the process of coupling the supplementary data D to the 3-dimensional model UM of the subject are displayed by a display unit 300 electrically connected to the calculating unit 200. Referring to FIGS. 3A and 9, the user may monitor whether the scan is correctly performed by visually checking the 3-dimensional model displayed on the display unit 300, and may perform the scan of the subject M using the first scanner 100 and the scan of the subject M using the second scanner 1 by clicking a first scan button B1 and a second scan button B2 on a user interface UI displayed on the display unit 300.

The above description is merely illustrative of the technical spirit of the present disclosure, and various modifications and changes will be possible without departing from the essential characteristics of the present disclosure by those skilled in the art to which the present disclosure pertains.

Accordingly, the embodiments disclosed in the present disclosure are not intended to limit the technical spirit of the present disclosure but to describe them, and the scope of the technical spirit of the present disclosure is not limited by these embodiments. The scope of the present disclosure should be construed by the appended claims, and all technical spirits within the scope equivalent thereto should be construed as being included in the scope of the present disclosure.

### INDUSTRIAL APPLICABILITY

The present disclosure provides the data integration method of the 3-dimensional scanner that derives the precise scan results by combining (integrating) the scan data acquired by the second scanner to the scan data acquired by the first scanner, and the system using the same.

1. A data integration method of a 3-dimensional scanner, the method comprising:
a first scan operation of generating first raw data by capturing the entire shape of a subject by a first scanner;
a second scan operation of generating second raw data by continuously capturing a partial shape of the subject by a second scanner;
a data converting operation of converting the first raw data generated in the first scan operation and the second raw data acquired from the second scan operation into file data of the same format by a calculating unit; and
a data combining operation of combining the data in the second scan operation converted in the converting operation and the data of the first scan operation converted in the converting operation to overlap each other by the calculating unit.

2. The method of claim 1,
wherein the first scanner includes an imaging unit having a predetermined angle and a predetermined distance interval toward the subject in order to generate the first raw data by capturing the subject.

3. The method of claim 2,
wherein the imaging unit of the first scanner captures the subject illuminated by light irradiated through a light projector formed in the first scanner.

4. The method of claim 1,
wherein the first scanner further includes
a first rotating unit coupled to one surface thereof to be rotatable clockwise or counterclockwise with respect to one axis, and formed to be bent in one direction, and a second rotating unit coupled to one end of the first rotating unit, and rotatable clockwise or counterclockwise with respect to an axis different from that of the first rotating unit.

5. The method of claim 1,
wherein the second scanner has a freely adjustable capturing angle and capturing distance for the subject, and continuously captures the partial shape of the subject so that the partial shapes of the subject overlap.

6. The method of claim 5,
wherein the second scanner is a handheld scanner including a case that is drawn into and drawn out from an oral cavity, and is formed with an opening that is open so that a state inside the oral cavity is incident therein in the form of light through one end, an imaging unit disposed inside the case, and configured to accommodate light incident through the opening of the case, a light irradiation unit disposed at one side of the imaging unit, and configured to emit light to irradiate the state inside the oral cavity through the opening, and an optical element configured to illuminate the subject by refracting or reflecting light generated from the light irradiation unit, and cause light reflected from the subject to enter the imaging unit.

7. The method of claim 1,
wherein the second raw data is 3-dimensional surface data.

8. The method of claim 6,
wherein light emitted from the light irradiation unit is structured light having a specific pattern.

9. The method of claim 1,
wherein a format of the file data converted in the data converting operation is voxel data having a format of 3-dimensional volume data.

10. A data integration method of a 3-dimensional scanner, the method comprising:
a first scan operation of scanning a subject through a first scanner;
a modeling operation of forming a 3-dimensional model of the subject based on data acquired in the first scan operation by a calculating unit;
a second scan operation of scanning a specific area of the subject corresponding to a supplementary area requiring an additional scan in the 3-dimensional model through the second scanner; and
a supplementing operation of supplementing the supplementary area based on data acquired in the second scan operation by the calculating unit.

11. The method of claim 10,
wherein the supplementing operation overlaps or replaces the data acquired in the second scan operation with at least a part of the data acquired in the first scan operation.

12. The method of claim 10,
wherein the first scan operation scans the entire shape of the subject at a preset capturing angle and capturing distance, and the second scan operation scans a partial shape of the subject at a free capturing angle and capturing distance.

13. The method of claim 12,
wherein the preset capturing angle and capturing distance in the first scan operation are changeable while the first scan operation is performed.

14. A data integration system of a 3-dimensional scanner, the data integration system comprising:
a first scanner configured to scan a subject at a preset capturing angle and capturing distance;
a second scanner configured to scan the subject at a free capturing angle and capturing distance; and
a calculating unit configured to supplement a supplementary area requiring an additional scan in a 3-dimensional model of the subject implemented by the scan data of the first scanner with the scan data of the second scanner.

15. The data integration system of claim 14,
wherein the first scanner and the second scanner are connected to a device including the calculating unit wirelessly or by wire.

16. The data integration system of claim 14,
wherein the first scanner and the calculating unit are configured as an integrated device, and the second scanner is connected to the integrated device wirelessly or by wire.

17. The data integration system of claim 14, further including a display unit configured to display the 3-dimensional model.

18. The data integration system of claim 14,
wherein the second scanner is a handheld scanner including a case that is drawn into and drawn out from an oral cavity, and is formed with an opening that is open so that a state inside the oral cavity is incident therein in the form of light through one end, an imaging unit disposed inside the case, and configured to accommodate light incident through the opening of the case, a light irradiation unit disposed at one side of the imaging unit, and configured to emit light to irradiate the state inside the oral cavity through the opening, and an optical element configured to illuminate the subject by refracting or reflecting light generated from the light irradiation unit, and cause light reflected from the subject to enter the imaging unit.
